(19) United States
(12) Patent Application Publication
(10) Pub. No.: US 2020/0110353 A1
(43) Pub. Date: Apr. 9, 2020

(54) OPPOSING-MEMBER CAPACITANCE DETECTION METHOD AND IMAGE FORMING APPARATUS

(71) Applicant: Konica Minolta Inc., Tokyo (JP)

(72) Inventor: KUNIAKI KASHIWAKURA, Toyohashi-shi (JP)

(21) Appl. No.: 16/562,338

(22) Filed: Sep. 5, 2019

(30) Foreign Application Priority Data
Oct. 9, 2018 (JP) 2018-191079

(51) Int. Cl. G03G 15/00; G03G 15/20; G03G 15/08

(52) U.S. Cl. CPC G03G 15/5037; G03G 15/2025; G03G 2215/025; G03G 2215/00632; G03G 15/0851

(57) ABSTRACT

An image forming apparatus includes: a capacitance detector that detects capacitance of an opposing member disposed opposite to a photoconductor, wherein the capacitance detector detects the capacitance of the opposing member, based on a result of measurement of a current flowing due to potential difference between a voltage applied to the opposing member and the photoconductor being charged.

The entire disclosure of Japanese patent Application No. 2018-191079, filed on Oct. 9, 2018, is incorporated herein by reference in its entirety.

### BACKGROUND

### Technological Field

The present invention relates to an opposing-member capacitance detection method an apparatus.

### Description of the Related Art

When an opposing member disposed opposite to a photoconductor such as a charging roller or a transfer roller is contaminated with toner, the capacitance varies, which adversely affecting an image to be formed, for example, generation of image noise. Therefore, when occurrence of such contamination is discriminated on the basis of detection of the capacitance of the opposing member, countermeasures such as adjustment of image forming conditions, execution of a cleaning mode, and output of a service call are implemented. Such implementation avoids adversely affecting or reduces adverse effects on an image to be formed (refer to, for example, JP 2004-191801 A).

JP 2004-191801 A discloses a technique of detecting the capacitance with an alternating current (AC) power source. That is, separate preparation of an AC power source is required, which may have an issue of increase cost.

### SUMMARY

The present invention has been made to solve such an issue associated with the above conventional technique, and an object of the present invention is to provide a capacitance detection method and an image forming apparatus capable of detecting the capacitance of an opposing member while increase in cost being reduced.

To achieve the abovementioned object, according to an aspect of the present invention, an image forming apparatus reflecting one aspect of the present invention comprises: a capacitance detector that detects capacitance of an opposing member disposed opposite to a photoconductor, wherein the capacitance detector detects the capacitance of the opposing member, based on a result of measurement of a current flowing due to potential difference between a voltage applied to the opposing member and the photoconductor being charged.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an explanatory block diagram of an image forming apparatus according to an embodiment of the present invention;

FIG. 2 is an explanatory block diagram of a contamination-status discrimination program illustrated in FIG. 1;

FIG. 3 is an explanatory schematic view of an image former and a transferer illustrated in FIG. 1;

FIG. 4 is a circuit diagram for describing combined capacitance in calculation of the combined capacitance of an opposing member;

FIG. 5 is a graph for describing phase difference and frequency in calculation of the combined capacitance;

FIG. 6 is a schematic chart for describing the relationship between cyclic variation of photoconductor surface potential and charging output indicated in FIG. 5;

FIG. 7 is a graph indicating the relationship between the phase difference and the frequency in calculation of the combined capacitance;

FIG. 8 is a graph indicating the relationship between current and the frequency in calculation of the combined capacitance;

FIG. 9 is a graph for describing stop of toner development at measuring the combined capacitance;

FIG. 10 is a schematic illustration for describing the contamination of the opposing member and variation in capacitance in parallel modelling;

FIG. 11 is a schematic illustration for describing the contamination of the opposing member and variation in capacitance in serial modelling;

FIG. 12 is a table for describing the details of change of image forming conditions;

FIG. 13 is an explanatory flowchart of a contamination-status discrimination method applied with an opposing-member capacitance detection method according to the embodiment of the present invention;

FIG. 14 is an explanatory flowchart of capacitance detection processing (step S11) illustrated in FIG. 13;

FIG. 15 is a schematic chart for describing Modification 1 according to the embodiment of the present invention;

FIG. 16 is a schematic illustration for describing an image of exposure output illustrated in FIG. 15;

FIG. 17 is a schematic illustration for describing an exposure area;

FIG. 18A is a schematic illustration for describing Modification 2 according to the embodiment of the present invention;

FIG. 18B is a schematic illustration for describing another exposure region different from an exposure region illustrated in FIG. 18A;

FIG. 18C is a schematic illustration for describing still another exposure region from the exposure regions illustrated in FIGS. 18A and 18B;

FIG. 19 is a schematic view for describing Modification 3 according to the embodiment of the present invention; and

FIG. 20 is a schematic view for describing Modification 4 according to the embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. Note that the dimensional ratios in the drawings are exaggerated for the convenience of description, and may differ from the actual ratios.

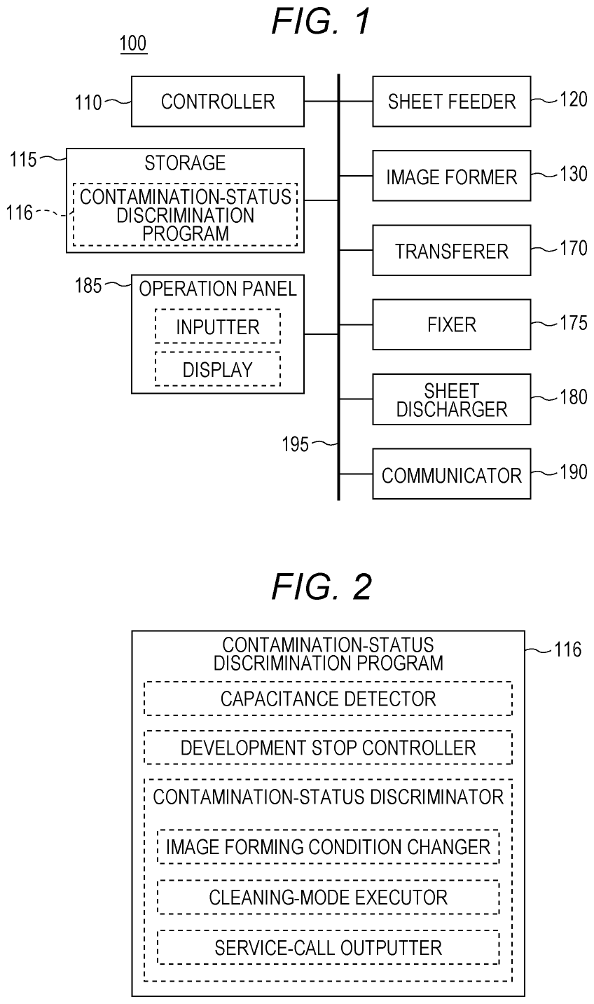

FIG. 1 is an explanatory block diagram of an image forming apparatus according to the embodiment of the present invention. FIG. 2 is an explanatory block diagram of a contamination-status discrimination program illustrated in FIG. 1.

An image forming apparatus 100 illustrated in FIG. 1 is used in order to form (print) an image with toner (developer) on a sheet as a recording medium, by using image data generated from a received print job. According to the present embodiment, the image forming apparatus 100 is detectable of the capacitance of an opposing member while increase in cost being reduced, and discriminable of the contamination status of the opposing member on the basis of the capacitance. The image forming apparatus 100 includes: a controller 110; a storage 115; a sheet feeder 120; an image former 130; a transferer 170; a fixer 175; a sheet discharger 180; an operation panel 185; and a communicator 190, and these constituents are connected mutually via a bus 195. Examples of the opposing member include a transfer member, a charging member, and a lubricant application member to be described later.

The controller 110 serves as a control circuit including a central processing unit (CPU) or an application specific integrated circuit (ASIC) that controls each constituent described above and executes various types of arithmetic processing in accordance with a program. Each function of the image forming apparatus 100 is exhibited by the CPU (the controller 110) executing a corresponding program.

The storage 115 includes, for example, a read only memory (ROM), a random access memory (RAM), a non-volatile memory, a solid state drive (SSD), a hard disk drive (HDD) that are combined appropriately. Examples of programs stored in the storage 115 include a contamination-status discrimination program 116 and a raster image processing (RIP) program.

As illustrated in FIG. 2, the contamination-status discrimination program 116 includes a capacitance detector, a development stop controller, and a contamination-status discriminator. The capacitance detector has a function of detecting the capacitance of time opposing member. The development stop controller has a function of stopping development of toner (movement of toner) in detection of the capacitance of the opposing member. The contamination-status discriminator includes an image forming condition changer, a cleaning-mode executor, and a service-call outputter. The contamination-status discriminator has a function of discriminating contamination status of the opposing member on the basis of the capacitance of the opposing member and has function of changing image forming conditions, executing a cleaning mode, or outputting a service call, in accordance with the contamination status.

Examples of the data stored in the storage 115 include the initial value of the capacitance of the opposing member, a print job, bitmap data converted with the RIP.

The sheet feeder 120 has a plurality of sheet feeding trays. Time sheet feeder 120 takes out a sheet from time corresponding sheet feeding tray according to an instruction from the controller 110, and conveys the sheet toward the image former 130.

The image former 130 forms a toner image on the sheet with an electrophotography process. The transferer 170 transfers the formed toner image onto the sheet. The fixer 175 applies pressure and heat to the sheet the transferred toner image to melt the toner and fixes the toner image.

The sheet discharger 180 includes a sheet discharge tray extending outside the apparatus, and discharges the printed (image-fixed) sheet to the sheet discharge tray.

The operation panel 185 includes an inputter and a display. The inputter includes, for example, a physical keyboard. The physical keyboard is to be used by the user in order to perform various instructions (inputs) such as character input, various settings, and start instruction. The display includes, for example, a liquid crystal display (LCD) or a touch panel, and notifies the user of a service call, progress of a print job, occurrence status of a sheet jamming, and currently changeable settings.

Examples of the user include a service person, and a service call promotes awareness of request for part replacement when a failure to be handled by the service person, such as failure occurrence in a non-consumable part. Examples of the failure occurrence in the non-consumable part include significant contamination of the opposing member.

The communicator 190 serves as an expansion device (local area network (LAN) board) that adds, to the image forming apparatus 100, a communication function for connecting to a computer having data such as a print Job, via a network. The network includes various networks such as a local area information network (local area network: LAN), a wide area information network (wide area network: WAN) with LANs connected via a dedicated line, the Internet, or a combination thereof. Examples of the standard for mutually connecting computers and network devices, include Ethernet (registered trademark) and fiber-distributed data interface (FDDI). Examples of the network protocol include transmission control protocol/internet protocol (TCP/IP).

Next, the image former 130 and the transferer 170 will be described in detail.

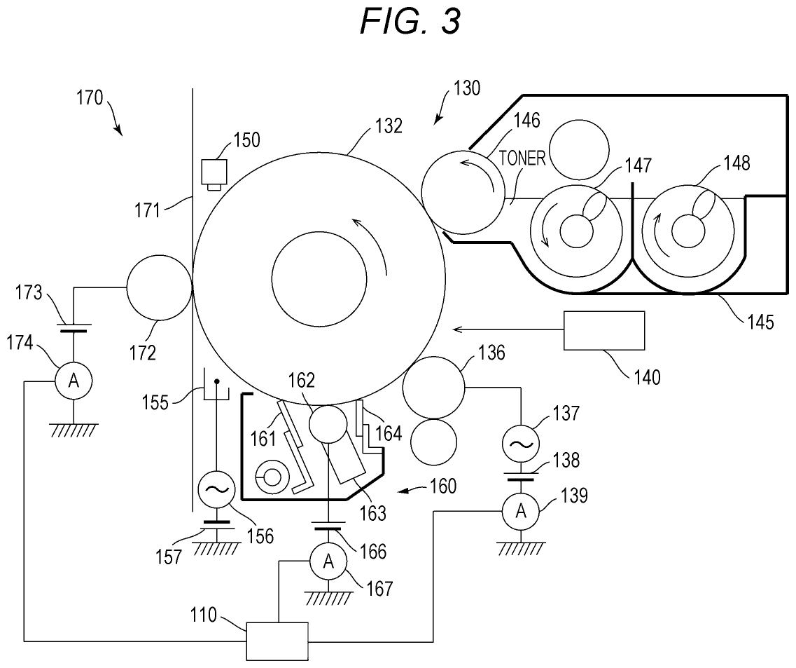

FIG. 3 is an explanatory schematic view for the image former and the transferer illustrated in FIG. 1.

As illustrated in FIG. 3, the image former 130 includes a photoconductor 132, a charger 135, an exposure device 140, a developing device 145, a pre-transfer eraser 150, a pre-cleaning charger 155, and a cleaner 160.

The photoconductor 132 includes a rotatable drum-shaped member having a photosensitive layer includes a resin such as polycarbonate containing an organic photo conductor (OPC). The photoconductor 132 has a rotational speed of, for example, several hertz.

The charger 135 is of a contact charging type, and includes a charging roller (charging member) 136, an AC power source 137, a direct current (DC) power source 138, and a phase difference detector 139.

The charging roller 136 serving an opposing member is disposed opposite to the photoconductor 132, in order to charge the photoconductor 132. The charging roller 136 includes a rubber roller having a coating layer or a surface modifying layer.

The AC power source 137 and the DC power source 138 are connected to the charging roller 136, and apply, to the charging roller 136, an oscillation voltage (bias voltage) obtained by superimposing an AC voltage on a DC negative voltage in order to charge the photoconductor 132. The DC power source 138 also applies a DC voltage for detecting the capacitance of the charging roller 136, to the charging roller 136.

The phase difference detector 139 includes an ammeter disposed between the DC power source 138 and the frame ground. The phase difference detector 139 is connected to the controller 110, and detects the phase difference between the current waveform of the charging roller 136 that has been measured and a photoconductor-surface potential waveform. The detected phase difference is used in order to calculate the capacitance of the charging roller 136, at the controller 110 (contamination-status discrimination program 116) and to discriminate the contamination status of the charging roller 136.

The exposure device 140 incorporates a scanning optical device, and exposes, on the basis of raster image data, the photoconductor 132 uniformly charged by the charging roller 136. Then the exposure device 140 drops the potential of an exposed portion of the photoconductor 132 to form a charge pattern (electrostatic latent image) corresponding to the image data.

The developing device 145 develops, with the toner, the electrostatic latent image formed on the photoconductor 132 to visualize the developed electrostatic latent image. The developing device 145 has a developing roller 146 and a plurality of stirring screws 147 and 148. The developing roller 146, and the stirring screws 147 and 148 are driven separately and rotatable independently.

The pre-transfer eraser 150 includes, for example, a light emitting diode (LED). The pre-transfer eraser 150 exposes the surface of the photoconductor after the image formation and removes the charge on the surface of the photoconductor. As a result, the pre-transfer eraser 150 removes redundant charge on the photoconductor, before transfer of the toner image from the photoconductor.

The pre-cleaning charger 155 includes a contactless charging device (e.g., corotron discharge electrode), and is connected to an AC power source 156 and a DC power source 157. The pre-cleaning charger 155 charges and discharges the photoconductor 132 after the transfer of the toner image formed on the photoconductor 132 and before cleaning of the photoconductor 132. The AC power source 156 and the DC power source 157 apply, to the pre-cleaning charger 155, an oscillation voltage (bias voltage) obtained by superimposing an AC voltage on a DC negative voltage in order to charge the photoconductor 132.

The cleaner 160 includes a cleaning blade 161, a lubricant application brush (lubricant application member) 162, a lubricant rod 163, a lubricant fixing blade 164, a DC power source 166, and a phase difference detector 167.

The cleaning blade 161 scraps (removes) a residual substance such as toner remaining on the surface of the photoconductor 132 so as to maintain the surface of the photoconductor 132 in a favorable state. The lubricant application brush 162 serving an opposing member is disposed opposite to the photoconductor 132, in order to apply lubricant to the photoconductor 132. The lubricant application brush is disposed downstream the cleaning blade 161 with respect to the rotational direction of the photoconductor 132 so as to rotate in a direction counter to the rotational direction of the photoconductor 132.

The lubricant rod 163 is in contact with the lubricant application brush 162 with a pressurizing spring (not illustrated). The lubricant fixing blade 164 is disposed downstream the lubricant rod 163 with respect to the rotational direction of the photoconductor 132, and is supported in contact with the photoconductor 132 so as to form a film with lubricant powder to be supplied from the lubricant rod 163. The DC power source 166 is connected to the lubricant application brush 162 and applies a DC voltage to the lubricant application brush 162 for detecting the capacitance of the lubricant application brush 162.

The phase difference detector 167 includes an ammeter disposed between the DC power source 166 and the frame ground. The phase difference detector 167 is connected to the controller 110, and detects the phase difference between the current waveform of the lubricant application brush 162 that has been measured and the photoconductor-surface potential waveform. The detected phase difference is used in order to calculate the capacitance of the lubricant application brush 162, at the controller 110 (contamination-status discrimination program 116) and to discriminate the contamination status of the lubricant application brush 162.

The transferer 170 includes an intermediate transfer belt 171, a primary transfer roller (transfer member) 172, a DC power source 173, a phase difference detector 174, and a secondary transfer roller (not illustrated).

The intermediate transfer belt 171 is wound around the primary transfer roller 172 and a plurality of rollers (not illustrated), and supported so as to run. The primary transfer roller 172 serving as an opposing member disposed opposite to the photoconductor 132 via the intermediate transfer belt 171. The primary transfer roller 172 is provided so as to attract electrostatically the toner image formed on the photoconductor 132 and transfer (primarily transfer) to the intermediate transfer belt 171. The primary transfer roller 172 includes, for example, a conductive foam roller.

The DC power source 173 is connected to the primary transfer roller 172, and applies a transfer voltage to the primary transfer roller 172. The DC power source 173 also applies a DC voltage for detecting the capacitance of the primary transfer roller 172, to the primary transfer roller 172.

The phase difference detector 174 includes an ammeter disposed between the DC power source 173 and the frame ground. The phase difference detector 174 is connected to the controller 110, and detects the phase difference between the current waveform of the primary transfer roller 172 that has been measured and the photoconductor-surface potential waveform. The detected phase difference is used in order to calculate the capacitance of the primary transfer roller 172, at the controller 110 (contamination-status discrimination program 116) and to discriminate the contamination status of the primary transfer roller 172.

The secondary transfer roller is disposed below the intermediate transfer belt 171, and transfers (secondarily transfers) the toner image formed on the intermediate transfer belt 171 onto the conveyed sheet.

Next, detection of the capacitance of the opposing member (charging roller, lubricant application brush, or primary transfer roller) will be described.

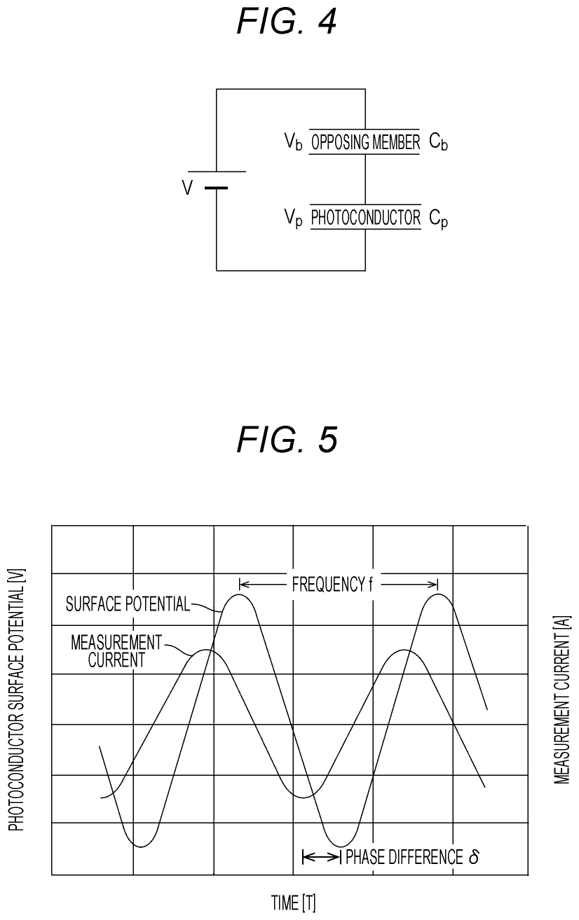

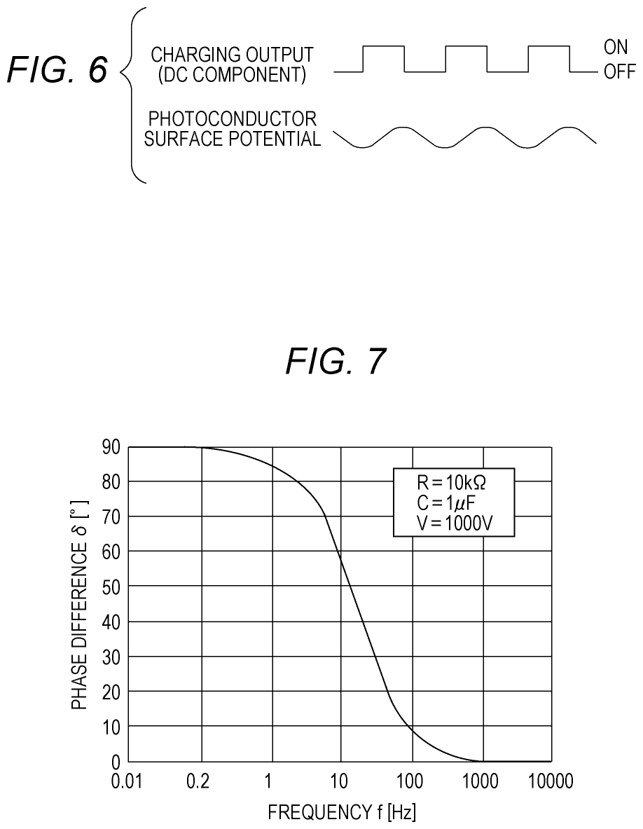

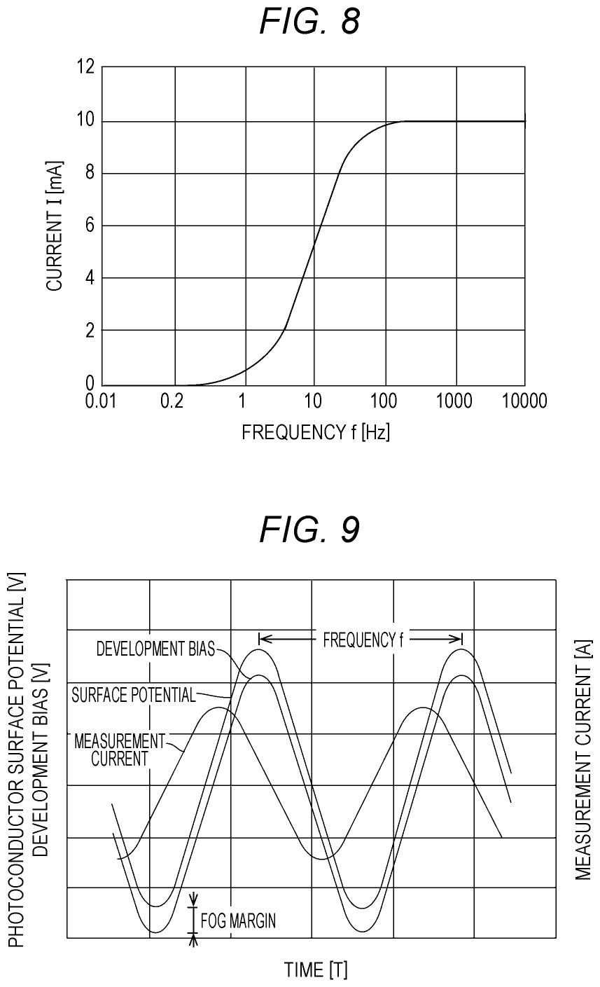

FIG. 4 is a circuit diagram for describing combined capacitance in calculation of the capacitance of the opposing member. FIG. 5 is a graph for describing phase difference and frequency in calculation of the combined capacitance. FIG. 6 is a schematic chart for describing the relationship between cyclic variation of photoconductor surface potential and charging output indicated in FIG. 5. FIG. 7 is a graph indicating the relationship between the phase difference and the frequency in calculation of the combined capacitance. FIG. 8 is a graph indicating the relationship between current and the frequency in calculation of the combined capacitance. FIG. 9 is a graph for describing stop of toner development at measuring the combined capacitance.

The opposing member is opposite to the photoconductor and in contact with the photoconductor directly or indirectly. The opposing member and the photoconductor are electrically connected in series. A DC voltage is applicable to the opposing member. Accordingly, the opposing member, the photoconductor, and the power source are included in the electric circuit such as illustrated in FIG. 4. Thus, the combined capacitance C is defined by Expression (1) below when the capacitance of the opposing member and the capacitance of the photoconductor are represented by C_{b} and Cₚ respectively. Therefore, the capacitance C_{b} of the opposing member is calculable if the capacitance Cₚ of the photoconductor and the combined capacitance C are obtained.

$$\begin{matrix}[ Mathematical Formula 1 ] & \\ C = \frac{{C}_{p} \cdot {C}_{b}}{{C}_{p} + {C}_{b}} & ( 1 )\end{matrix}$$

In contrast, the capacitance Cₚ of the photoconductor can be obtained separately. For example, the initial value of the capacitance Cₚ is experimentally obtained separately, and on the premise that the photoconductivity of the photoconductor does not vary in aging (film scraping is negligible), the obtained initial value is fixedly usable as the capacitance Cₚ of the photoconductor. In addition, assuming that the amount of wear is constant, the film thickness of the photoconductor from the durable pieces of sheets and then the capacitance Cₚ of the photoconductor is calculated, so that the calculated capacitance Cₚ is usable. Furthermore, a current flowing, into the photoconductor is measured and the capacitance Cₚ of the photoconductor from the surface potential of the photoconductor at that time, so that the calculated capacitance Cₚ is usable.

The combined capacitance C is defined by Expression (2) below, and the symbols f, R, and δ represent the frequency, resistance, and phase difference, respectively.

$$\begin{matrix}[ Mathematical Formula 2 ] & \\ C = \frac{1}{2 π fR \cdot tan δ} & ( 2 )\end{matrix}$$

The resistance R can is calculable by applying of a measurement voltage to the opposing member using the DC power source 138, 166, or 173, and performing of current measurement in the DC state.

The phase difference δ is detectable at the phase difference detector 139, 167, or 174 by control of photoconductor surface potential to cause the cyclic variation of the surface potential, and performing current measurement in the AC state. For example, as indicated in FIG. 5, when use of the frequency f causes the photoconductor surface potential to vary in a sine-wave shape, the measurement current also varies in a sine-wave shape to shift forward by the phase difference δ. As a result, the phase difference δ can be obtained.

Control of the charging output of the charging roller 136 can cause the cyclic variation of the photoconductor surface potential. For example, for the charging output having AC and DC voltages applied, as illustrated in FIG. 6, when the DC component turns ON, the photoconductor surface potential rises, whereas when the DC component turns OFF, the photoconductor surface potential drops. Thus, repetition of turning ON and turning OFF the DC component of the charging output can cause the cyclic variation of the photoconductor surface potential. Note that repetition of increasing and decreasing the DC component also can cause the cyclic variation of the photoconductor surface potential.

Next, there will be described the frequency f applied in detection of the capacitance of the opposing member.

For example, for a capacitor-resistance (CR) series circuit (resistor-capacitance (RC) series circuit), the phase difference δ and the current I are defined by Expressions (3) and (4) below.

$$\begin{matrix}[ Mathematical Formula 3 ] & \\ δ = {tan}^{- 1} ( \frac{1}{2 π fCR} ) & ( 3 ) \\ I = \frac{V}{\sqrt{{R}^{2} + {( 1 / 2 π fC )}^{2}}} & ( 4 )\end{matrix}$$

Thus, as illustrated in FIGS. 7 and 8, as the frequency f is higher, the phase difference δ is smaller, whereas the current I is larger. That is, it is preferable to increase the frequency fin term of the detection sensitivity of the current I, whereas it is preferable to decrease the frequency f inn term of the detection sensitivity of the phase difference δ. Thus the frequency f is set in view of the detection sensitivity of the current I and the detection sensitivity of the phase difference δ.

Therefore, first, an appropriate frequency f is set to detect the capacitance. Then, when the phase difference δ obtained in the detection of the capacitance is close to 0°, the detection sensitivity of the phase difference δ is low. Thus, the detection of the capacitance with the frequency f set lower is performed again, in contrast, when the phase difference δ obtained in the calculation of the capacitance is close to 90°, the detection sensitivity of the current I is low. Thus, the detection of the capacitance with the frequency f set higher is performed again.

That is, the detection of the capacitance is repeated while the frequency f is being changed, until the frequency fat which the phase difference δ ranges from 30 to 60° is identified. For example, in the example illustrated in FIG. 7, when the capacitance is detected at the frequency f near 10 Hz, the phase difference δ has a value of about 30 to 60°.

The detection of the capacitance is repeated in advance while the frequency f is being changed to identify a suitable frequency f, and the identified frequency f is applied, as a reference frequency, to the initial detection in the actual detection of the capacitance. As a result, the number of times of redetection is can be reduced.

As described above, the capacitance of the opposing member is detected, on the basis of the measurement result of the current flowing due to the potential difference between the voltage applied to the opposing member and the charged photoconductor. In particular, according to the present embodiment, there is provided a surface potential controller that cyclically varies the photoconductor surface potential. The phase difference between the current waveform measured by specifically cyclic variation of the photoconductor surface potential and the surface potential waveform is detected with a uniform voltage applied to the opposing member. Then the capacitance of the opposing member is detected with a value of the phase difference. In addition, the cyclic variation of the photoconductor surface potential is achieved by the cyclic variation of the output of the charging member.

That is, the detection of the capacitance of the opposing member is based on the current flowing through the opposing member, the current behaving as an apparent alternating current, due to the cyclic variation of the photoconductor surface potential with a constant voltage applied to the opposing member. Therefore, it is not required to separately prepare an AC power source for detecting the capacitance of the opposing member, so that increase in cost is reduced.

When the toner is developed at measuring the combined capacitance, the measurement current includes a current accompanying movement of the toner. Thus the measurement accuracy of the combined capacitance drops. Therefore, according to the present embodiment, there is provided the development stop controller that causes the developing device to stop development. When a current is measured in order to detect the capacitance, the development stop controller makes control such that the movement of the toner stops.

The stop of the toner development is achievable by synchronizing a development bias with the cycle variation of the photoconductor surface potential to set at a non-development voltage. For example, as illustrated in FIG. 9, maintaining the development bias about 100 to 200 V lower than the photoconductor surface potential (so-called fog margin) causes the toner development to stop.

Next, discrimination of the contamination status of the opposing member based on the capacitance of the opposing member will be described.

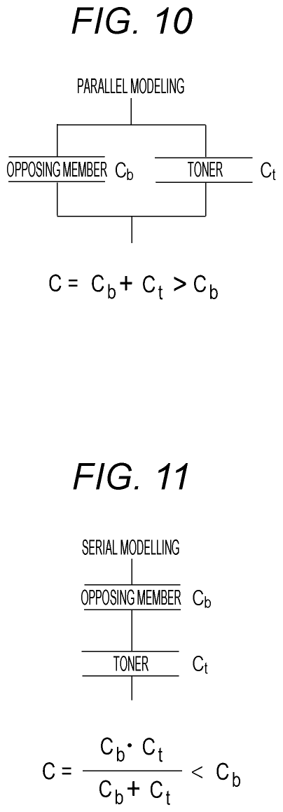

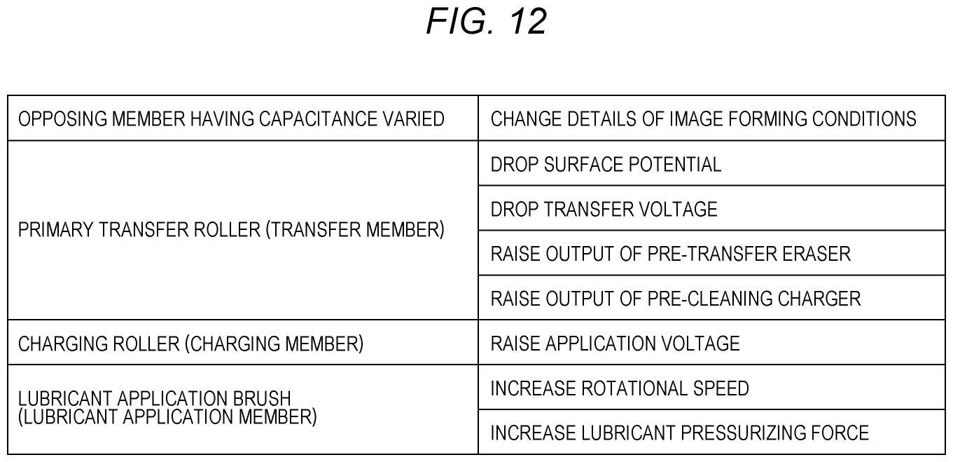

FIG. 10 is a schematic illustration for describing the contamination of the opposing member and variation in capacitance in parallel modelling. FIG. 11 is a schematic illustration for describing the contamination of the opposing member and variation in capacitance in serial modelling. FIG. 12 is a table for describing the details of change of image forming conditions.

Like the primary transfer roller including the conductive foam roller, in a case where the opposing member can be regarded as having pores to be filled with toner (dielectric), when the opposing member is contaminated with the toner, the capacitance (combined capacitance) C detected is the sum of the capacitance C_{b} of the opposing member and the capacitance Cₜ of the toner, as in the parallel modelling illustrated in FIG. 10. Thus, when the opposing member is contaminated with the toner, the capacitance to be detected rises.

Then, for example, when the capacitance of the primary transfer roller increases, the pore potential of an upstream portion of the transfer nip rises and discharge occurs at a white background portion. As a result, positive charge is injected into the photoconductor, and a risk increases in term of generation of an image memory.

In contrast, like the charging roller and the lubricant application brush, in a case where the opposing member can be regarded as solid and has the surface covered with toner (dielectric), when the opposing member is contaminated with the toner, as the serial modelling illustrated in FIG. 11, the capacitance C to be detected is obtained by dividing the product of the capacitance C_{b} of the opposing member and the capacitance Cₜ of the toner by the sum of the capacitance C_{b} of the opposing member and the capacitance Cₜ of the toner. Thus, when the opposing member is contaminated with the toner, the capacitance to be detected drops.

In addition, for example, decrease of the capacitance of the charging roller deteriorates the charging characteristics and the surface potential drops. As a result, a risk rises in term of fogging at a white background portion and high density in halftoning (uneven density). For the lubricant application brush, decrease of the capacitance deteriorates the performance of lubricant application and decreases the amount of lubricant on the photoconductor that leads variation in developability and transferability. As a result, uneven density in image becomes visible. That is, when the charging roller, the lubricant application brush, or the primary transfer roller serving as the opposing members each are contaminated with the toner, the capacitance varies and there is a possibility of adverse effect on an image. Therefore, it is preferable to take countermeasures to prevent image defects, in accordance with the contamination status due to the toner.

Examples of the countermeasures for preventing the image defects, include change of the image forming conditions in the case of slight contamination status; execution of the cleaning mode in the case of moderate contamination status and difficulty in handling with the change of the image forming conditions; and output of a service call for requirement of part replacement in the case of remarkable serious contamination status.

The image forming conditions to be changed are different depending on, for example, as indicated, in FIG. 12, whether the opposing member having the capacitance varied is the primary transfer roller (transfer member), the charging roller (charging member), or the lubricant application brush (lubricant application member).

For example, in a case where the opposing member is the primacy transfer roller, positive discharge tends to easily occur upstream the transfer nip, due to increase in the capacitance. As a result, a risk rises in term of generation of an image memory. Thus, the image forming conditions are changed to prevent the generation of the image memory. Specifically, the image forming conditions to be changed are “dropping the surface potential”, “dropping the transfer voltage”, “lighting up the pre-transfer eraser (raising the output)”, and “raising the output of the pre-cleaning charger”. At this time, when the amount of variation is excessive, there is a possibility that a fault such as an image defect may occur. Thus, it is preferable to appropriately adjust the image forming conditions such that the image forming conditions do not deviate from the range of the optimum state.

In a case where the opposing member is the charging roller, the surface potential drops due to decrease in the capacitance, and a risk rises in term of occurrence of toner fogging at a white background portion and uneven density in halftoning. Thus, the surface potential is stabilized by “raising an application voltage”. The rising of the application voltage is achieved by increase in the AC component.

In a case where the opposing member is the lubricant application brush, the capacitance decreases due to contamination of the lubricant application brush. The contamination deteriorates the performance of lubricant application to cause uneven lubricant application. The uneven lubricant application varies transferability and developability, and uneven density becomes visible. Thus, the amount of lubricant application is increased by “increasing the rotational speed” or “increasing a lubricant pressurizing force” and the performance of lubricant application is maintained to prevent occurrence of uneven lubricant application.

Note that when the charging member is contaminated with the toner, a case may arise in which the capacitance increases depending on the configuration of the charging member. Increase in the capacitance of the charging member may cause the application voltage to be excessive. However, in a case Where control is made such that the application voltage drops, there is a possibility that charging failure occurs at an uncontaminated portion. Thus, basically, it is preferable not to mike control such that the application voltage drops.

In addition, when the lubricant application member is also contaminated with the toner, a case may arise in which the capacitance increases depending on the configuration of the lubricant application member. For the lubricant application member, the performance of lubricant application deteriorates even increase in the capacitance. Thus, similar to the case where the capacitance drops, the amount of lubricant application is increased by “increasing the rotational speed” or “increasing a lubricant pressurizing force” and the performance of lubricant application is maintained to prevent occurrence of uneven lubricant application.

In the cleaning mode to be executed for the case of difficulty in handling with the change of the image forming conditions, for example, in the case where the opposing member is the primary transfer roller, application of a reverse bias, a certain amount of rotation in a non-development state, and the like are performed. In addition, in the case where the opposing member is the charging roller, for example, increase in a pressurizing force of a cleaning roller, application of a reverse bias, idle rotation after stop of the application voltage, and the like are performed. Furthermore, in the case where the opposing member is the lubricant application brush, for example, a certain amount of rotation in a non-development state, electrical cleaning by application of a bias, and the like are performed.

The service call to be executed for the case of difficulty in handling with the execution of the cleaning mode is output to the operation panel 185 to promote awareness of request for part replacement to the user. However, the output of the service call is not particularly limited to this mode. For example, in a case where the image forming apparatus 100 is remotely managed by a remote management server disposed in a service center via a network, a service call may be notified (output) to the remote management server, and the remote management server may call for service to a service person or may notify the service person of the name of a part to be replaced.

Next, there will be described a contamination-status discrimination method applied with an opposing-member capacitance detection method according to the embodiment of the present invention. Note that in a case where the contamination status is discriminated for a plurality of opposing members, the order of execution is not particularly limited. For example, the order is appropriately set, in view of the configuration such as disposition location in the rotation direction of the photoconductor 132, and a unit or the like that cyclically varies the photoconductor surface potential. Furthermore, depending on the above configuration, it is also allowable to simultaneously discriminate the contamination status (detects the capacitance) of the plurality of opposing members.

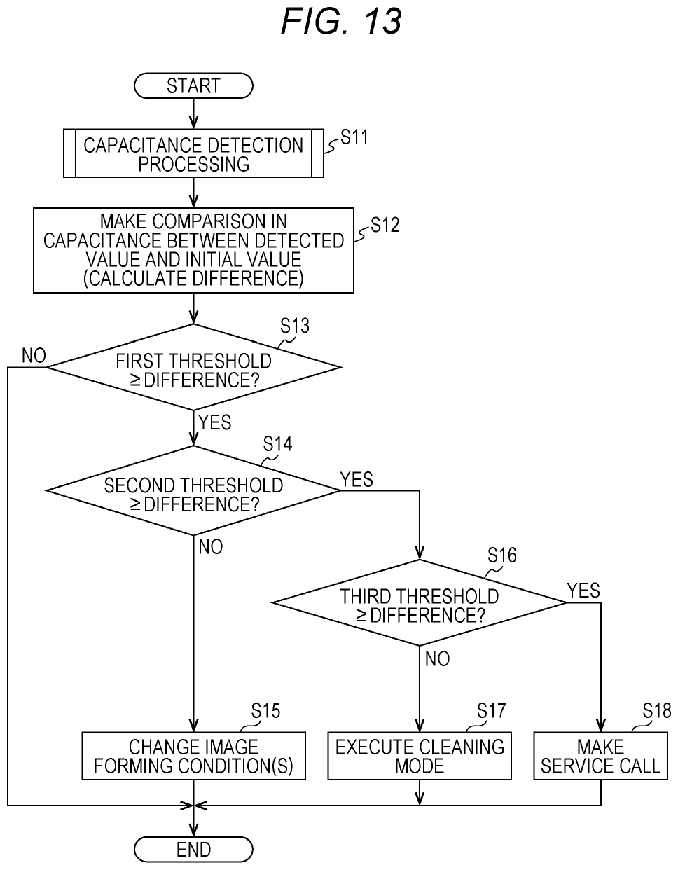

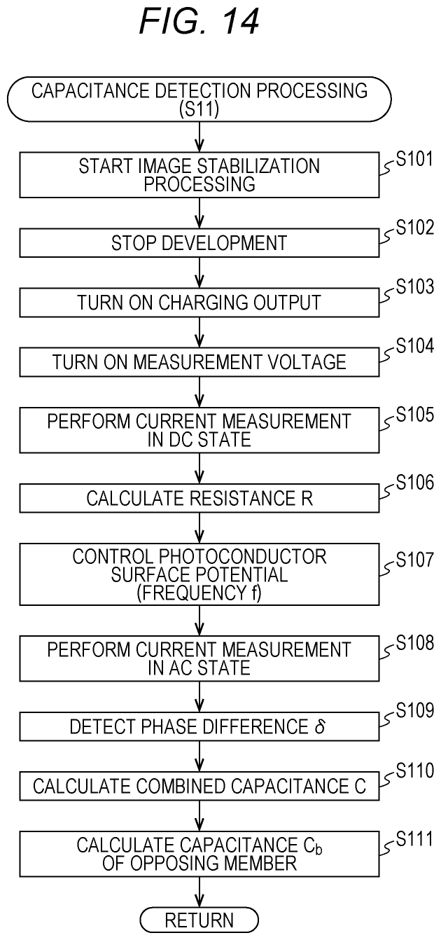

FIG. 13 is an explanatory flowchart of the contamination-status discrimination method applied with the opposing-member capacitance detection method according to the embodiment of the present invention. FIG. 14 is an explanatory flowchart of capacitance detection processing (S11) illustrated in FIG. 13. Note that the algorithm illustrated in the flowcharts in FIGS. 13 and 14 is stored as the contamination-status discrimination program 116 and is executed by the controller 110 (CPU).

First, as illustrated in FIG. 13, capacitance detection processing is performed (step S11). The capacitance detection processing is incorporated as part of image stabilization operation, and the capacitance of the opposing member at the present time is detected. After that, comparison is made in the capacitance of the opposing member between the detected value and the initial value (step S12). The initial value of the capacitance of the opposing member is stored in the storage 115.

It is determined whether, in the capacitance of the opposing member, the difference between the detected value and the initial value is a first threshold or greater (step S13). The first threshold is a predetermined value that defines the allowable range of the capacitance of the opposing member.

In a case where it is determined that the difference is less than the first threshold (step S13: NO), the processing is terminated (ends) because the capacitance of the opposing member is included (located) in the allowable range.

In a case where it is determined that the difference is the first threshold or greater (step S13: YES), it is determined whether the difference is a second threshold or greater (step S14). The second threshold is a predetermined value that defines a range to be handled with change of the image forming conditions.

In a case where it is determined that the difference is less than the second threshold and the contamination status of the opposing member is slight (step S14: NO), the imaging forming conditions are changed (step S15), and then the processing is terminated. Note that the image forming conditions to be changed are different depending on whether the opposing member is the primary transfer roller, the charging roller, or the lubricant application brush (refer to FIG. 2).

In a case where it is determined that the difference is the second threshold or greater (step S14: YES), it is determined whether the difference is a third threshold or greater (step S16). The third threshold is a predetermined value that defines a range to be handled with the execution of the cleaning mode.

In a case where it is determined that the difference is less than the third threshold and the contamination status of the opposing member is moderate (step S16: NO), the cleaning mode is executed for the opposing member (step S17), and then the processing is terminated.

In a case where it is determined that the difference is the third threshold or greater and part replacement is required due to remarkably serious contamination status of the opposing member (step S16: YES), a service call is made (step S18), and then the processing is terminated.

Steps S11 to S18 correspond to the contamination-status discriminator. Steps S11, S15, S17, and S18 correspond to the capacitance detector, the image forming condition changer, the cleaning-mode executor, and the service-call outputter, respectively.

Next, the capacitance detection processing (step S11) will be described with reference to FIG. 14.

First, image stabilization processing in which capacitance detection operation incorporated starts (step S101). Then, in order to prevent a measurement current from including a current accompanying movement of toner, development of the toner is stopped (step S102). The stop of the development is achieved by maintaining the development bias about 100 to 200 V lower than the photoconductor surface potential (refer to FIG. 9). Step S102 corresponds to the development stop controller.

After that, the charging, output turns ON and then a voltage is applied to the photoconductor (step S103). At the same time, a measurement voltage turns ON and then the measurement voltage is applied to the opposing member (step S104). Then, the current measurement in the DC state is performed (step S105), and the resistance R is calculated (step S106).

Next, control of the photoconductor surface potential causes the cyclic variation of the surface potential (e.g., variation in a sine-wave shape having frequency f) (step S107). The cyclic variation of the surface potential is caused by repetition of turning ON and turning OFF of the DC component of the charging output. Then, the current measurement in the AC state is performed (step S108), and the phase difference δ (refer to FIG. 5) is detected (step S109).

After that, on the basis of the frequency f in the control of the photoconductor surface potential and the resistance R and the phase difference δ that have been obtained, the combined capacitance C (refer to Expression (2)) is calculated (step S110). Then, on the basis of the calculated combined capacitance C and the capacitance Cₚ of the photoconductor obtained separately, the capacitance C_{b} (refer to Expression (1)) of the opposing member is calculated (step S111).

The capacitance detection is not limited to being incorporated as part of the image stabilization operation, and may also be performed independently.

Next, Modifications 1 to 4 according to the embodiment of the present invention will be described sequentially.

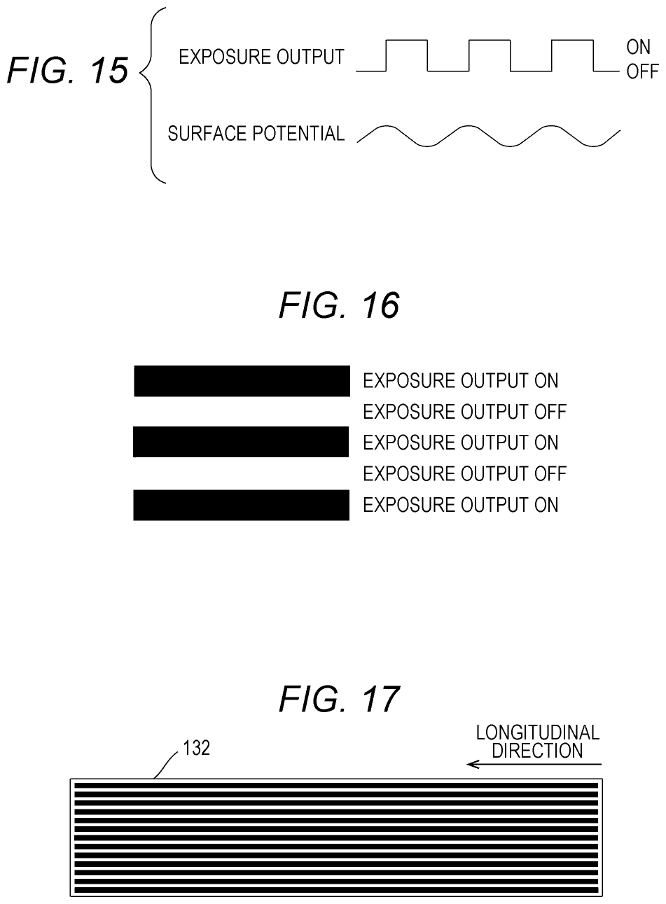

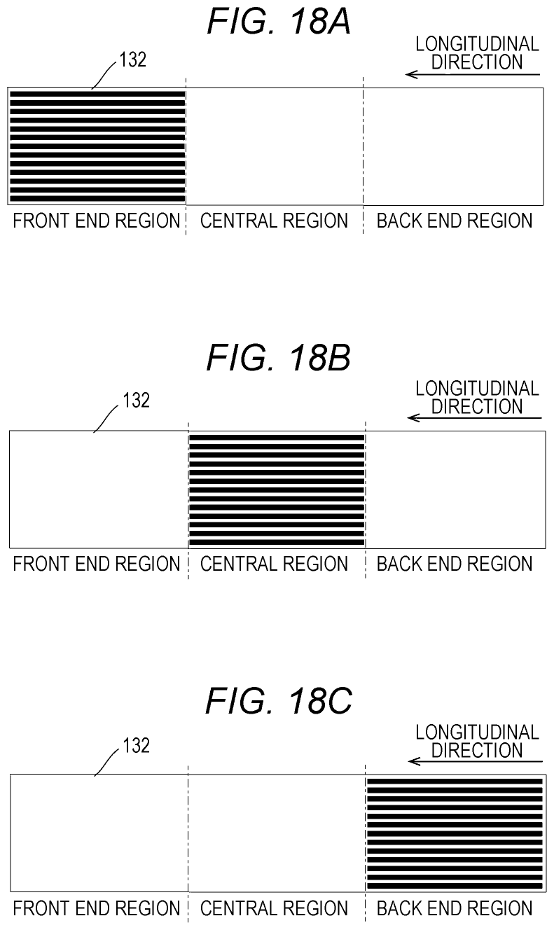

FIG. 15 is a schematic chart for describing Modification 1 according, to the embodiment of the present invention. FIG. 16 is a schematic illustration for describing an image of exposure output illustrated in FIG. 15. FIG. 17 is a schematic illustration for describing an exposure area. FIG. 18A is a schematic illustration for describing Modification 2 according to the embodiment of the present invention. FIG. 18B is a schematic illustration for describing another exposure region different from an exposure region illustrated in FIG. 18A. FIG. 18C is a schematic illustration for describing still another exposure region different from the exposure regions illustrated in FIGS. 18A and 18B.

The cyclic variation of the photoconductor surface potential is not limited to the mode in which the control of the charging output of the charger 135 causes the cycle variation of the photoconductor surface potential. However, the cyclic variation of the photoconductor surface potential can also be caused by the control of the exposure output of the exposure device 140.

For example, as illustrated in FIG. 15, the photoconductor surface potential drops when the exposure output turns ON and rises when the exposure output is turns OFF. Thus, it is allowable to cause the cyclic variation of the photoconductor surface potential by repetition of turning ON and turning OFF the exposure output.

At this time, when the ON of the exposure output is indicated by a black portion and the OFF of the exposure output is indicated as illustrated in FIG. 16, the exposure area is indicated such as in FIG. 17. In such a case, the exposure area occupies the entirety of the area in the longitudinal direction along the rotary shaft of the photoconductor 132. Thus, it is allowable to collectively detect contamination due to toner in the longitudinal direction. The cyclic variation of the photoconductor surface potential can also be caused by repetition of increasing and decreasing the exposure output.

Note that contamination due to toner may be localized in the longitudinal direction of the photoconductor 132. For example, in many cases, such contamination due to toner is serious at both ends of the photoconductor 132 compared with the vicinity of the center. Thus, it is allowable to improve the detection sensitivity of partial contamination due to toner by segmentation the exposure area. For example, as illustrated in FIGS. 18A to 18C, the surface of the photoconductor 132 is segmented into a front end region, a central region, and a back end region in the longitudinal direction along the rotary shaft of the photoconductor 132. These regions are sequentially and individually exposed such that the surface potential cyclically varies individually.

The number of segments of the surface of the photoconductor 132 and the order of exposure (cyclically varying the surface potential) are not limited to the above mode, and can be changed appropriately. For example, it is also allowable to simultaneously expose the front end region and the back end region (causing the cyclic variation of the surface potential).

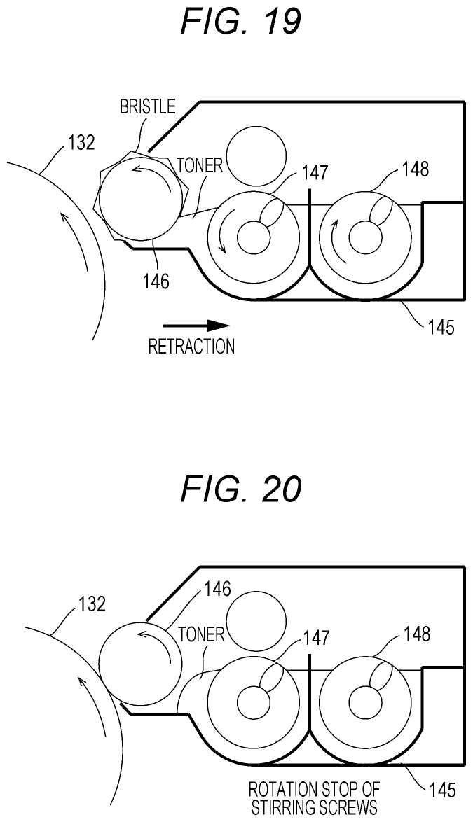

FIG. 19 and FIG. 20 are schematic views for respectively describing Modification 3 and Modification 4 according to the embodiment of the present invention.

The development stop controller that stops the development of the toner is not limited to the mode with the development bias. For example, as illustrated in FIG. 19, the developing device 145 retracts (is spaced apart) from the photoconductor 132 to prevent the bristles of the toner on the developing roller 146 from coming into contact with the photoconductor 132. As a result, it is allowable to stop the development of the toner (movement of the toner).

In addition, as illustrated in FIG. 20, it is allowable to stop the development of the toner by stopping the rotation of the stirring screws 147 and 148 and rotating the developing roller 146. In such a case, the supply of developer to the developing roller 146 is shut off, and developer on the developing roller 146 is exhausted or is in a very small amount, so that the toner is prevented from being developed.

As described above, according to the present embodiment, it is not required to separately prepare an AC power source for detecting the capacitance of the opposing member, so that increase in cost is reduced. Therefore, there can be provided the capacitance detection method and the image forming apparatus capable of detecting the capacitance of the opposing member while increase in cost being reduced. In particular, according to the present embodiment, the capacitance detection method is used to discriminate the contamination status, so that it is allowable to reduce increase in cost on the contamination-status discrimination.

The present invention is not limited to the embodiment described above, and various alternations can be made within the scope of the claims. For example, it is also allowable to appropriately combine Modifications 1 and 2 and Modifications 3 and 4. In addition, the opposing member is not limited to the charging roller, the lubricant application brush, and the primary transfer roller. Furthermore, the capacitance of the opposing member is not limited to the mode in which the capacitance of the opposing member is used to discriminate the contamination status of the opposing member.

The contamination-status discrimination program according to the embodiment of the present invention can also be achieved by a dedicated hardware circuit. In addition, the contamination-status discrimination program can be provided with a computer readable recording medium such as a universal serial bus (USB) memory or a digital versatile disc-read only memory (DVD-ROM). Alternatively, the contamination-status discrimination program can also be provided online via a network such as the Internet. In such a case, the contamination-status discrimination program is usually stored in a storage device such as a magnetic disk device included in the storage. Furthermore, the contamination-status discrimination program can be provided as a single piece of application software, or can be provided, as one function, by integration into different software.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a capacitance detector that detects capacitance of an opposing member disposed opposite to a photoconductor,
wherein the capacitance detector detects the capacitance of the opposing member, based on a result of measurement of a current flowing due to potential difference between a voltage applied to the opposing member and the photoconductor being charged.

2. The image forming apparatus according to claim 1, further comprising:
a contamination-status discriminator that discriminates contamination status of the opposing member, based on the capacitance of the opposing member.

3. The image forming apparatus according to claim 2,
wherein the capacitance detector
includes a surface potential controller that cyclically varies photoconductor surface potential, and
detects, after phase difference between a current waveform measured by specifically cyclic variation of the photoconductor surface potential and, a surface potential waveform is detected with a uniform voltage applied to the opposing member, the capacitance of the opposing member, based on the phase difference.

4. The image forming apparatus according to claim 3, further comprising:
a charging member that charges the photoconductor,
wherein the surface potential controller cyclically varies output of the charging member, to cyclically vary the photoconductor surface potential.

5. The image forming apparatus according to claim 3, further comprising:
an exposure device that exposes the photoconductor,
wherein the surface potential controller cyclically varies exposure output of the exposure device, to cyclically vary the photoconductor surface potential.

6. The image forming apparatus according to claim 5,
wherein the exposure device individually exposes each of a plurality of regions obtained by segmentation of a surface of the photoconductor in a longitudinal direction along a rotary shaft of the photoconductor, and
the surface potential controller cyclically varies individually surface potential of each of the plurality of regions.

7. The image forming apparatus according to claim 1, further comprising:
a developing device that develops, with toner, an electrostatic latent image formed on the photoconductor; and
a hardware processor that stops development by the developing device in detection of the capacitance by the capacitance detector.

8. The image forming apparatus according to claim 1, wherein the opposing member serves as a transfer member that transfers a toner image formed on the photoconductor.

9. The image forming apparatus according to claim 1, wherein the opposing member serves as a charging member that charges the photoconductor.

10. The image forming apparatus according to claim 1, wherein the opposing member serves as a lubricant application member that applies lubricant to the photoconductor.

11. The image forming apparatus according to claim 2, wherein in a case where the contamination-status discriminator discriminates that the contamination status of the opposing member is a predetermined value or greater, an image forming condition is changed.

12. The image forming apparatus according to claim 11, wherein the opposing member serves as a transfer member that transfers a toner image formed on the photoconductor,
the image forming condition includes a transfer voltage, and
in a case Where the contamination-status discriminator discriminates that contamination status of the transfer member is the predetermined value or greater, the transfer voltage drops.

13. The image forming apparatus according to claim 11, wherein the opposing member serves as a transfer member that transfers a toner image formed on the photoconductor,
the image forming condition includes a photoconductor surface potential, and
in a case where the contamination-status discriminator discriminates that contamination status of the transfer member is the predetermined value or greater, the photoconductor surface potential drops.

14. The image forming apparatus according to claim 11, further comprising:
a pre-transfer eraser that removes redundant charge on the photoconductor before a toner image is transferred from the photoconductor,
wherein the opposing member serves as a transfer member that transfers the toner image formed on the photoconductor,
the image forming condition includes output of the pre-transfer eraser, and
in a case where the contamination-status discriminator discriminates that contamination status of the transfer member is the predetermined value or greater, the output of the pre-transfer eraser rises.

15. The image forming apparatus according to claim 11, further comprising:
a pre-cleaning charger that discharges a surface of the photoconductor after a toner image formed on the photoconductor is transferred and before the photoconductor is cleaned,
wherein the opposing member serves as a transfer member that transfers the toner image formed on the photoconductor,
the image forming condition includes output of the pre-cleaning charger, and
in a case where the contamination-status discriminator discriminates that contamination status of the transfer member is the predetermined value or greater, the output of the pre-cleaning charger rises.

16. The image forming apparatus according to claim 11,
wherein the opposing member serves as a charging member that charges the photoconductor,
the image forming condition includes a charging application voltage to be applied by the charging member in order to charge the photoconductor, and
in a case where the contamination-status discriminator discriminates that contamination status of the charging member is the predetermined value or greater, the charging application voltage rises.

17. The image forming apparatus according to claim 11,
wherein the opposing member serves a lubricant application member that applies lubricant to the photoconductor,
the image forming condition includes a rotational speed of the lubricant application member, and
in a case where the contamination-status discriminator discriminates that contamination status of the lubricant application member is the predetermined value or greater, the rotational speed of the lubricant application member increases.

18. The image forming apparatus according to claim 11,
wherein the opposing member serves as a lubricant application member that applies lubricant to the photoconductor,
the image forming condition includes a lubricant pressurizing force of the lubricant application member, and
in a case where the contamination-status discriminator discriminates that contamination status of the lubricant application member is the predetermined value or greater, the lubricant pressurizing force of the lubricant application member increases.

19. The image forming apparatus according to claim 2, further comprising:
a cleaning mode for the opposing member,
wherein in a case where the contamination-status discriminator discriminates that contamination status of the opposing member is a predetermined value or greater, the cleaning mode is executed.

20. The image forming apparatus according to claim 2, further comprising:
an outputter that outputs a service call for prompting part replacement of the opposing member,
wherein in a case where the contamination-status discriminator discriminates that contamination status of the opposing member is a predetermined value or greater, the outputter outputs the service call.

21. An opposing-member capacitance detection method comprising:
detecting capacitance of an opposing member disposed opposite to a photoconductor in an image forming apparatus, based on a result of measurement of a current flowing due to potential difference between a voltage applied to the opposing member and the photoconductor being charged.

22. The opposing-member capacitance detection method according to claim 21, wherein the capacitance of the opposing member is used in order to discriminate contamination status of the opposing member.
